(19) United States
(12) Patent Application Publication
(10) Pub. No.: US 2012/0107468 A1
(43) Pub. Date: May 3, 2012

(54) METHOD FOR SUSPENDING PARTICLES IN ALCOHOLIC LIQUID COMPOSITION AND CORRESPONDING LIQUID COMPOSITION

(75) Inventors: David DOYLE, Windsor (CA); Martine LELEU, Longpont Sur Orge (FR)

(73) Assignee: PERNOD RICARD, Paris (FR)

(21) Appl. No.: 13/346,929

(22) Filed: Jan. 10, 2012

Related U.S. Application Data
(63) Continuation of application No. PCT/EP2010/062015, filed on Aug. 18, 2010.

(51) Int. Cl. C12H 1/14; A23L 1/054

(52) U.S. Cl. 426/271; 426/573; 426/592

(57) ABSTRACT

The present invention relates to a method for suspending particles in an alcoholic liquid composition. The method comprises providing an alcoholic liquid composition having a particular alcoholic content and employing low acyl gellan gum to suspend particles in the composition. The invention also relates to an alcoholic liquid composition having a plurality of particles suspended in an alcoholic beverage employing low acyl gellan gum.

### CROSS REFERENCE TO RELATED APPLICATION

This is a continuation of International Patent Application Number PCT/EP2010/062015 filed on 18 Aug. 2010, the contents of which are herein incorporated by reference in their entirety.

### BACKGROUND OF THE INVENTION

This invention generally relates to a method of suspending particles in an alcoholic beverage and to an alcoholic beverage having suspended particles.

It is known to include particles suspended in a drink in order to enhance its visual attractiveness to the customer. Such particles can be, for example, beads, fruit pulp, fruit flakes, especially coconut flakes, or gold flakes.

A food grade pigment providing sparkling visual effect, recently released by the Merck Company under the name CANDURIN®, allows for a wider range of particles able to give drinks eye-catching and distinctive looks.

More precisely, CANDURIN® is a food grade pigment based on titanium dioxide (European code E171) and/or iron oxides (E172) coated around a natural and inert carrier made of potassium aluminium silicate (E555, mica). This pigment allows for making affordable silver-like or gold-like particles that can be introduced into beverages.

Such particles are more visually attractive if they are suspended homogeneously throughout the beverage and do not sediment to the bottom of the beverage bottle nor float to the top. This is especially important when the bottle is resting on a shelf or table. Moreover, it is advantageous if the particles remain suspended without the consumer having to shake the bottle regularly or every time the consumer wishes to use the bottle.

Several methods exist in order to keep the added particles in suspension.

First, the density of the particles may be adjusted to the density of the beverage, balancing gravity. However, such method is very complex to implement and may require either adding weighting agents to the beverage and/or emulsifying the drink. Moreover, this kind of solution to the problem is very difficult to control and generally works for one set of conditions that can easily change during the life cycle of the beverage. This solution is also generally limited to small and lightweight particles.

It is also known to add gold flakes to an effervescent beverage (namely Champagne) in order to have them swirl with the bubbles when the bottle is opened. However, as long as the bottle remains closed, the flakes will tend to sediment and agitation of the bottle will be required to distribute the flakes throughout the drink.

Another more suitable solution is to use stabilizing agents and more particularly hydrocolloids such as, for example, gum arabic, xanthan gum, pectin, starch or carboxymethylcellulose. However, relatively large quantities of these materials may be required to achieve effective stabilization. A major drawback of these materials is that they generally can affect beverage flavour and feel.

It is indeed paramount that when using a suspending additive, the thickness, taste, and more generally all the organoleptic properties of the original beverage not be noticeably altered. Consumers should experience the same taste and the same feel in the mouth that they like with the original drink.

Additionally, one of the drawbacks that should be avoided is the forming of gelling points that would stick to the bottle. Thick tears of wine, rivulets, and streaks should also be avoided.

To this end, it has been found that gellan gum would be a suitable material to achieve these goals if used properly.

Gellan gum is a fermentation product, a hydrocolloid produced by the microorganism Sphingomonas elodea and is commercially available from CP KELCO under the name KELCOGEL. It is a biological product that has naturally found applications in numerous biological areas such as food, personal care, etc.

Structurally, gellan gum is a straight-chain molecule based on repeating units of glucose, rhamnose and glucuronic acid. Gellan gum, in its native form, also possesses two acyl substituents, or functional groups, acetate and glycerate, located on the same glucose residue. On average, there is one glycerate per repeat unit and one acetate per every two repeat units.

This native form, commonly referenced as “high-acyl gellan gum” can be converted into a “low-acyl” by treatment with alkali. This deacylation process is employed to remove as much as possible and almost completely the acyl groups from the molecular chains.

The presence, or lack thereof, of substantial amounts of acyl functional groups affects the properties of the resultant gellan gum. Prior to a deacylation process, the “high-acyl” content provides a hydrocolloid structure able to form a gel that is soft, elastic, and non-brittle. The deacylation process alters the performance of the hydrocolloid structure, rendering the gel that is formed firmer and more brittle than formed by native gellan gum.

As such, those skilled in the art would readily appreciate the differences between the two forms of gellan gum. Specifically, those skilled in the art would appreciate that, rather than referring to intermediates or specific values between the high-acyl and zero-acyl forms, the term ‘low acyl’ is in reference to the fact that the form of gellan gum is considered to be deacylated or essentially deacylated.

Gellan gum, both in native form and deacylated form, is available in the form of a white powder and needs to be hydrated before use. Hydration is generally performed using heat and/or sequestrants which are intended to trap cations, mainly divalent ones, that tend to inhibit hydration of the gellan gum and that are present in the water (although use of de-ionized water is preferred, but cations from the gellan powder remain).

Regarding gel formation, gellan gum solutions form gels on cooling and gel formation depends on numerous factors, in particular on the presence of cations in the solution. However, adding cations is not always necessary. The presence of cations will increase the gel setting temperature and divalent cations such as calcium and magnesium are known to be the most effective in this regard.

WO 96/00018 describes the use of gellan gum for various purposes and in particular for suspending and stabilizing fruit pulp and for slightly gelling a drink to stabilize it. Gellan gum is hydrated right in the drinkable solution, using sodium citrate in some cases. Gelling can be obtained by using calcium lactate when additional cations are needed.

A further and more detailed application of gellan gum is described in WO 96/22700 and WO 97/15200. In those documents, a pre-gel solution using deionized water (slightly acidic) is made up for hydrating the gellan gum before adding a small amount of said pre-gel solution to the drinkable liquid composition. Sodium citrate is used as a buffer and sequestrant in the pre-gel solution. A gel is obtained simply on cooling.

In the food industry, the use of gellan gum has particularly developed for making jellies and for stabilizing pulp containing fruit drinks, milk-based beverages, and carbonated drinks.

Although previously cited documents mentioning alcoholic beverages provide a few examples, it appears that the specifically provided examples pertain to beverages with relatively low alcohol content. Indeed it has been found that the use of gellan gum in alcoholic solutions is difficult and presents numerous problems.

More precisely, it has been noticed that, with alcoholic solutions, following common prior art recipes using gellan gum would lead to a cloudy solution. insufficient suspension time, and/or increased viscosity.

It must indeed be noted that high alcohol containing drinks, such as liquors or distillates (vodka and whiskey, for example) are clear solutions and, as mentioned before, the addition of gellan gum and particles should not modify the clear aspect of the original solution, its viscosity, or how it feels in the mouth of a consumer.

The main reason for the above-mentioned problem may be that alcohol tends to precipitate gellan gum from solution and, therefore, only moderate levels are tolerated.

A high level of sugar in a beverage, especially in a liquor, may also affect the gelling properties of gellan gum.

It is also important to note that gellan gum is highly sensitive to cations in the solution.

Moreover, storage and consumption time of alcoholic beverages may reach up to two years and, thus, it is important that particles suspended in such beverages remain suspended for a sufficient amount of time.

### SUMMARY OF THE INVENTION

The present invention provides an alcoholic beverage having stably suspended particles and a method for preparing such a beverage.

To this end, the present invention relates to a method for suspending particles in an alcoholic liquid composition comprising providing a beverage having an alcoholic liquid composition, providing a plurality of particles in the alcoholic liquid composition, and adding low acyl gellan gum to the alcoholic liquid composition.

It has been surprisingly found that low acyl gellan gum indeed showed satisfactory behaviour in a high alcohol containing solution. This allowed for the selection of low acyl gellan gum to prepare an alcoholic beverage while, in comparison, the use of high acyl gellan gum was found to yield to poor results, showing turbidity, cloudiness and poor stability. This was particularly surprising since high acyl gellan gum is known to show better compatibility with alcohol.

In reference to alcoholic liquid compositions with suspended particles, it is to important to understand that the viscosity of the final beverage should not be noticeably affected and should be very close to the viscosity of the original beverage that is sold without the particles. A highly viscous, partially visual, or totally gelled product is not considered to be an alcoholic liquid composition.

In a preferred method, the alcoholic liquid composition has an alcohol content that is equal to or above about 15% by volume (vol), which corresponds to the range of spirits.

According to a first embodiment, the alcoholic liquid composition has an alcohol content that is between about 17% vol to about 30% vol, more particularly about 25% vol.

According to a second embodiment, the alcoholic liquid composition has an alcohol content between about 30% vol to about 50% vol, more particularly about 40% vol.

According to a preferred embodiment, the alcoholic liquid composition is a liquor. A liquor is a spirit drink having a sugar content of more than 100 g/l (grams per liter) and is obtained by aromatising, naturally or artificially, ethanol produced by distilling fermented grain, fruit or vegetables. It excludes beer, wine, or cider.

According to another preferred embodiment, the alcoholic liquid composition is based on a grain distillate such as, for example, whiskey or vodka.

Of course, other types of alcohol such as, for example, cane spirit or rum may be used.

Preferably, the amount of low acyl gellan gum, in the final alcoholic liquid composition is up to about 0.5 g/l. Most preferably, the amount of low acyl gellan gum is about 0.15 to about 0.4 g/l¹.

Additionally, the method of suspending particles in an alcoholic liquid composition can comprise adding a sequestrant. Preferably, the sequestrant is chosen from the group consisting of salts of monovalent ions, preferably sodium and/or potassium ions, most preferably sodium ions.

Advantageously, the sequestrant can also be used, at least partially, as a gelling agent. This means that the sequestrant can be added in a higher amount than required as a sequestrant.

Preferably, the sequestrant is a citrate. Most preferably, the sequestrant is sodium citrate.

It is important to note, however, that other sequestrants can be used, such as, for example, potassium citrate, sodium hexametaphosphate, and sodium tripolyphosphate. However, sodium citrate is known for not noticeably affecting organoleptic properties of a product.

Accordingly, in a preferred embodiment, the amount of sodium citrate is at least equal to, or higher than, about 1.5 times the amount of low acyl gellan gum, preferably up to about 100 times the amount of low acyl gellan gum, more preferably up to about 67 times the amount of low acyl gellan gum.

According to one embodiment, the amount of sodium citrate in an alcoholic liquid composition is about 50 times the amount of low acyl gellan gum.

According to a second embodiment, the amount of sodium citrate is between about 10 to about 15 times the amount of low acyl gellan gum in the alcoholic liquid composition.

Additionally, if required, the present method comprises adding a gelling agent, particularly when the alcohol content of the final composition is higher than 30% vol. Preferably, the gelling agent is calcium lactate.

Suitably, calcium lactate is added in an amount lower than the amount of low acyl gellan gum, preferably lower than about 0.75 times the amount of low acyl gellan gum, preferably lower than about 0.5 times the amount of low acyl gellan gum.

In a preferred embodiment, the sequestrant is used as a gelling agent without adding another gelling agent, particularly when the alcohol content of the final composition is below about 30% vol.

It has indeed surprisingly also been found that, contrary to usual recommendations, the use of divalent cations for gelling the gellan gum was prejudicial, leading to poor solution, insufficient suspension time of the particles, formation of gelling points, wine tears with lumps. and other drawbacks. It has, thus, surprisingly been found that, while cations were required for gelling gellan in an alcoholic containing solution, monovalent ions were much more efficient and had a paramount role in gelling the gellan gum in addition to their role in sequestrants.

### DESCRIPTION OF THE DRAWINGS

These and other features, aspects, and advantages of the present invention will become better understood when the following detailed description is read with reference to the accompanying FIG. 1, wherein

FIG. 1 shows the result of particles suspended in an alcohol-containing solution according to Example 4 herein.

### DETAILED DESCRIPTION OF THE INVENTION

Without being bound by any theory, it is believed that divalent ions, which are usually preferred for gelling gellan gum, tend to crosslink the polymeric chains, while monovalent ions cannot crosslink the chains. Due to the poor compatibility of gellan gum with alcohol, and the necessity to maintain the organoleptics properties in a beverage, it is essential to form a gel having a very large gel matrix. It appears that when using calcium, however, the gel matrix may be too tight due to the crosslinking and consequently, the polymeric chain may tend to gather and form gelling points or locally viscous droplets.

For high alcohol containing solutions, because of the poor compatibility of gellan gum with alcohol, which tends to precipitate the gellan gum, it may be necessary to strengthen the gel matrix using a small amount of calcium cations that can help to form a stronger gel while keeping it sufficiently loose to meet the necessary requirements.

According to an advantageous embodiment of the method of the present invention a pre-gel solution is made for hydrating low acyl gellan gum in water, preferably deionised or demineralised, together with sequestrant, before mixing with a complementary alcoholic composition to form the final alcoholic liquid composition.

Preferably, the pre-gel solution is made with at least about 40% vol of the final water content of the alcoholic liquid composition.

Preferably again, hydrating the low acyl gellan gum in the pre-gel solution is performed under vigorous mixing, at least about 170 rpm or equivalent, using, for example, a shear pump.

Additionally, sugar, preferably saccharose or fructose for example, especially High Fructose Corn Syrup (referred to as HFCS 55) can be added to the pre-gel solution, preferably in an amount up to about 250 g/l of the final alcoholic liquid composition.

According to a first embodiment, the pre-gel solution, after mixing and hydrating the low acyl gellan gum, is maintained at a temperature higher than the setting point of the low acyl gellan gum until mixing with the complementary alcoholic composition, preferably a temperature between about 65° C. and about 68° C.

According to a second embodiment, the pre-gel solution is, after mixing and hydrating the low acyl gellan gum, cooled below the setting point of the low acyl gellan gum, preferably below about 30° C., most preferably around about 25° C.

Preferably, shearing is maintained in the pre-gel solution until mixing it with the complementary alcoholic composition.

It is important to note that, alternately, the total sugar content can be added to the complementary alcoholic composition. Depending on the heating of the pre-gel solution, the sugar can become brown and color the pre-gel solution.

Additionally, the complementary alcoholic composition comprises flavour citric acid, preferably in an amount up to about 2 g/l, and/or sugar, preferably saccharose or HFCS 55, preferably to bring the final total sugar content in the alcoholic liquid composition up to about 250 g/l. Such levels given can be adjusted as required for taste.

In addition, the pre-gel solution and the complementary alcoholic composition can be mixed under agitation, preferably vigorous mixing, preferably at about 170 rpm, preferably with a high speed pump, preferably about 1000 l/h (liters per hour) flow rate.

Preferably, the pre-gel solution and the complementary alcoholic composition are mixed under controlled temperature, aiming at a target temperature below the setting point of the low acyl gellan gum, preferably, below about 25° C., most preferably around about 20° C.

In complement, the method further comprises the step of adding particles to the mixture formed by the pre-gel solution and the complementary alcoholic composition, preferably under slight agitation in order to ensure proper homogenization.

Preferably, and provided as non-limiting examples, suspended particles can be gold flakes, fruit pieces or fruit pulp, coconut pulp pieces, CANDURIN®, food grade pigments, and the like. The present invention also relates to an alcoholic liquid composition product obtained by a method according to the invention.

The present invention will be better understood in view of the following detailed description of preferred embodiments given by way of example.

### Example 1

### Preparation of a Solution at 25% Vol Alcohol (Liquor Type)

The concentrations of the components in the solution of Example 1 are given as follows with regard to the final volume of the solution.

Components:
Alcohol: an amount sufficient to reach between 25% vol
Sugar (saccharose): from 50 to 250 g/l, depending on the final desired composition of the liquor
Citric Acid: from 0 to 2 g/l depending on the desired final pH of the liquor
Low Acyl Gellan Gum: 0.2 g/l
Sodium Citrate: from 2 to 3 g/l
Flavors depending on the liquor: Flavours are generally used in small amounts and do not sensibly affect the overall cationic charge of the solution
Demineralized water: sufficient amount for 1 liter of final solution

Operating Process:

In a first recipient, a pre-gel solution is made according to the following procedure:
Dry mix the gellan gum, sugar (all or part, may also not be added at this step but in the complementary alcoholic composition), and sodium citrate. A dry mix facilitates a homogeneous mix.
Add cool demineralised water, preferably as much water as possible, and preferably more that 40% of the final water amount of the solution.
Heat the solution at about 85° C. for 5 minutes and dissolve the solid products under proper vigorous agitation, preferably at about 170 rpm, or by using a shear pump.
Add remaining sugar or part of the remaining sugar.
Maintain the temperature of the first recipient between 65 and 68° C.

In a second recipient, the complementary alcoholic composition is made according to the following procedure:

Dissolve the citric acid into water and add the alcohol.

Maintain the temperature between 21 and 23° C.

A final solution is made according to the following procedure:
Using a high speed pump having a 1000 l.h⁻¹ flow rate, add the content of the second recipient to the content of first recipient maintaining vigorous agitation at 170 rpm.
Add the remaining water if necessary.
Maintain the temperature of the solution between 48 and 21° C.
Rapidly cool the whole solution using a thermal exchanger to reach a target temperature of 20° C.
Add the desired particles to the solution under slight agitation for homogenization. Sit time may be required.

It is important to note that, in this example, the pre-gel solution is maintained above the setting point of the gellan gum. Thus, the gel sets when the full solution is prepared and the solution cooled at about 20° C. Thus, the amount of water present when the gel sets is maximum and the gellan gum is hydrated as much as possible.

The agitation speed and pump flow rate are mere indications for a laboratory scale example and may need to be adapted for scale up.

### Example 2

### Preparation of a Solution at 40% Vol Alcohol (Grain Distillate Type Such as Vodka or Whiskey)

Concentrations of the components are given with regard to the final volume of the solution.

For distillates, a maximum sugar content is 50 g/l and the beverage is not acidified with citric acid.

Components:
Alcohol: sufficient amount for reaching between 40% vol
Low Acyl Gellan Gum: 0.36 g/l
Sodium Citrate: 0.54 g/l
Sodium Lactate: 0.225 g/l For a high alcohol containing solution, addition of calcium cations may be required. However, the amount is kept as low as possible and most of the gelling is accomplished by the sodium cations.
Flavours depending on the final desired beverage.
Demineralized water: sufficient amount for 1 liter of final solution

Operating Process:

In a first recipient, a pre-gel solution is made according to the following procedure:
Dry mix the gellan gum and sodium citrate.
Add cool demineralised water, preferably as much water as possible, and preferably more than 40% of the final water amount of the solution.
Heat the solution at about 85° C. for 5 minutes and dissolve the solid products under proper agitation, preferably at around 170 rpm.
Add the remaining sugar or part of the remaining sugar.
The temperature of the first recipient is maintained between 65 and 68° C.

In a second recipient, the complementary alcoholic composition is made according to following procedure:

Dissolve the citric acid into water and add the alcohol.

Maintain the temperature between 21 and 23° C.

A final solution is made according to the following procedure:
Using a high speed pump having a 1000 l/h flow rate, add the content of the second recipient to the content of first recipient keeping agitating vigorously at 170 rpm.
Add remaining water if necessary.
Maintain the temperature of the solution between 48 and 21° C.
Rapidly cool the whole solution using and thermal exchanger to reach a target temperature of 20° C.
Add the desired particles into the solution under slight agitation for homogenization.
Sit time may be required.

It is important to note that, in this example, the pre-gel solution is maintained above the setting point of the gellan gum. Thus, the gel sets when the full solution is prepared and the solution cooled at 20° C. Thus, the amount of water present when the gel sets is at a maximum and the gellan gum is hydrated as much as possible.

Agitation speed and pump flow rate are mere indications for a laboratory scale example and may need to be adapted for scale up.

### Example 3

### Preparation of a Solution at 25% Vol Alcohol (Liquor Type, Larger Scale)

In a first recipient, a pre-gel solution, called part A, is prepared:

Fill a tank, at room temperature, with 1800 kg of cool reverse osmosis (deionized) water.

Under agitation, add 30 kg sodium citrate and mix until dissolved (test also made with 40 kg sodium citrate).

Add 0.6 kg of gellan (KELCOGEL F low acyl gellan gum) to the tank while mixing.

The solution should remain clear and no clumps should form.

Under maintained agitation, gellan gum is hydrated by heating the solution up to 90° C. for 3 to 5 minutes.

After hydration, the solution is cooled down to a target temperature of 25° C. under maintained shear agitation.

The solution should remain clear.

It is important to note that, in this example, the pre-gel solution is cooled below the setting point of the gellan gum. Although, the solution remains fluid, pumpable and not noticeably gelled, the gellan gum has set.

Separately, a complementary alcoholic composition, called part B, is prepared in a second recipient. To do this, the following ingredients are blended: Water (320 kg), sugar (liquid sucrose 57.9 Brix; 1230.8 kg), alcohol (Neutral Spirit at 96% abv, 705.5 kg), flavours, and citric acid (3.2 kg).

Proper agitation is used in order to ensure homogeneity of the blend.

The final alcoholic liquid composition is prepared by combining part A and part B under vigorous mixing. The temperature of the blend is preferably controlled and maintained at a target temperature under 28° C., preferably 20° C. The temperature is mainly kept under the setting temperature of the gellan gum.

Finally, the particles are added and put in suspension under slight agitation. The particles suspend immediately.

It is important to note that, depending on the amount of sodium citrate added and its ratio to gellan gum, some sit time may be required up to twelve hours, the higher the ratio the lower the sit time.

Results

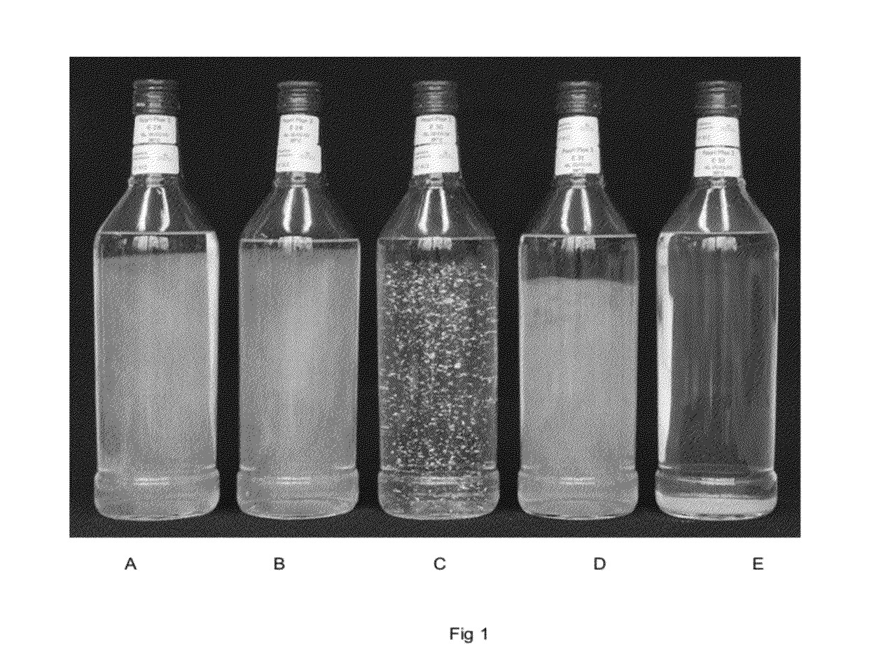

FIG. 1 shows some comparative results of particles suspended in a 25% vol. alcohol containing solution in labelled bottles.

Main components: 200 g/l sugar; 2 g/l citric acid and 0.2 g/l low acyl gellan gum prepared according to example 1.

Bottle A shows suspended particles of silver-like CANDURIN® using 3 g/l of sodium citrate as sequestrant, a gelling agent according to the invention, and no added flavour.

Bottle B shows suspended particles of silver-like CANDURIN® using 3 g/l of sodium citrate as sequestrant, a gelling agent, and added flavour.

Bottle C shows suspended particles of gold using 3 g/l of sodium citrate as sequestrant, a gelling agent, and added flavours.

Bottle D shows suspended particles of silver-like CANDURIN® using 2 g/l of sodium citrate as sequestrant, gelling agent, and added flavours.

Bottle E shows suspended particles of silver-like CANDURIN® using 1 g/l of sodium citrate as sequestrant, gelling agent, and added flavours.

All five bottles were stored at 35° C. for 4.5 months.

First, between experiments A and B, it is to be noted that the presence of flavors did not noticeably affect the performances.

Second, between experiments B and C, it is to be noted that the type of particles did not noticeably affect the performances.

Third, and a main point, between experiments B, D and E, it is to be noted that performances are degradated with a lower amount of sodium citrate and that particles are completely settled at the bottom with an amount of 1 g/l sodium citrate, that is to say 5 times the amount of low acyl gellan gum, while bottle B and D had sodium citrate amounting to, respectively, 15 and 10 times the amount of low acyl gellan gum.

Below are results giving decantation height (in percentage of the liquid height) for bottles B, D and E stored at various temperatures.

| sodium citrate | | |
|---|---|---|
| 1 g/l | 2 g/l | 3 g/l |

At 4° C.:

| | | | |
|---|---|---|---|
| 1 month | 50 | 25 | 1 |
| 2 months | 50 | 25 | 2.5 |
| 4.5 months | 50 | 25 | 2.5 |

At 20° C.:

| | | | |
|---|---|---|---|
| 1 month | 100 | 2.5 | 1 |
| 2 months | 100 | 5 | 2.5 |
| 4.5 months | 100 | 5 | 5 |

At 35° C.:

| | | | |
|---|---|---|---|
| 1 month | 100 | 17.5 | 5 |
| 2 months | 100 | 20 | 7.5 |
| 4.5 months | 100 | 20 | 7.5 |

It will thus be seen that the goals set forth above, among those made apparent from the preceding description, are efficiently attained and, since certain changes may be made in carrying out the above method without departing from the spirit and scope of the invention, it is intended that all matter contained in the above description shall be interpreted as illustrative and not in a limiting sense.

It is also understood that the following claims are intended to cover all of the generic and specific features of the invention herein described and all statements of the scope of the invention which, as a matter of language, might be said to fall therebetween.

Particularly it is to be understood that in said claims ingredients or compounds recited in the singular are intended to include compatible mixtures of such ingredients wherever the sense permits.

1. A method for suspending particles in an alcoholic liquid composition, the method comprising providing a beverage having an alcoholic liquid composition, providing a plurality of particles in the alcoholic liquid composition, and adding low acyl gellan gum to the alcoholic liquid composition.

2. The method according to claim 1, wherein the alcohol content of the alcoholic liquid composition is at least about 15% vol.

3. The method according to claim 1, wherein the amount of low acyl gellan gum is up to 0.5 g/l of the alcoholic liquid composition.

4. The method according to claim 1, further comprising adding a sequestrant to the alcoholic liquid composition, wherein the sequestrant is selected from the group consisting of salts of monovalent ions.

5. The method according to claim 4, wherein the sequestrant is a citrate.

6. The method according to claim 5, wherein the sequestrant is sodium citrate and the amount of sodium citrate is equal to, or higher than, 1.5 times the amount of low acyl gellan gum and up to about 100 times the amount of low acyl gellan gum.

7. The method according to claim 1, further comprising adding a gelling agent to the alcoholic liquid composition, wherein the alcohol content of the alcoholic liquid composition is greater than about 30% vol.

8. The method according to claim 7, wherein the gelling agent is calcium lactate, the gelling agent being added in an amount less than about 0.75 times the amount of low acyl gellan gum.

9. The method according to claim 1, further comprising adding a sequestrant that is used as a gelling agent with other gelling agents, wherein the alcohol content of the alcoholic liquid composition is less than about 30% vol.

10. The method according to claim 1, further comprising making a pre-gel solution for hydrating the low acyl gellan gum in water with a sequestrant before mixing with a complementary alcoholic composition to form the alcoholic liquid composition.

11. The method according to claim 10 wherein the pre-gel solution is made with at least about 40% vol of the total water content of the alcoholic liquid composition.

12. The method according to claim 10, wherein hydrating the low acyl gellan gum in the pre-gel solution is performed under vigorous mixing.

13. The method according claim 10, wherein a sugar is added to the pre-gel solution in an amount up to 250 g/l of the alcoholic liquid composition.

14. The method according to claim 10, further comprising, after mixing and hydrating the low acyl gellan gum, maintaining the pre-gel solution at a temperature higher than setting point of the low acyl gellan gum until mixing with the complementary alcoholic composition.

15. The method according to claim 10, further comprising, after mixing and hydrating the low acyl gellan gum, cooling the pre-gel solution below setting point of the low acyl gellan gum.

16. The method according to claim 10, wherein shearing is maintained in the pre-gel solution until mixing the pre-gel solution with the complementary alcoholic composition.

17. The method according to claim 10, wherein the complementary alcoholic composition comprises flavor, citric acid, and/or sugar.

18. The method according to claim 10, wherein the pre-gel solution and the complementary alcoholic composition are mixed under agitation.

19. The method according to claim 10, wherein the pre-gel solution and the complementary alcoholic composition are mixed under a controlled temperature wherein the target temperature is below setting point of the low acyl gellan gum.

20. The method according to claim 10, further comprising adding particles to a mixture formed by the pre-gel solution and the complementary alcoholic composition.

21. An alcoholic liquid composition product made by the method according to claim 1.

22. An alcoholic liquid composition comprising particles suspended in an alcoholic beverage, wherein low acyl gellan gum is present in the alcoholic liquid composition for suspending the particles.
